(19) United States
(12) Patent Application Publication
(10) Pub. No.: US 2011/0066843 A1
(43) Pub. Date: Mar. 17, 2011

(54) MOBILE MEDIA PLAY SYSTEM AND METHOD

(76) Inventors: Brent Newman, Sammamish, WA (US); Xiaodong Fu, Herndon, VA (US)

(21) Appl. No.: 12/560,826

(22) Filed: Sep. 16, 2009

(51) Int. Cl. H04L 9/32

(52) U.S. Cl. 713/153

(57) ABSTRACT

A mobile play device rights-managed media system and method are provided herein.

### FIELD

The present disclosure relates generally to digital media, and more particularly, to a system and method for providing rights-managed media to a mobile media play device.

### BACKGROUND

Mobile media play devices have enjoyed increasing popularity in recent years. Mobile media play devices may include handheld computers, wireless telephones, portable media players, personal digital assistants (“PDAs”), and the like. Over time, mobile media playback devices have acquired increasing functionality, and many such devices now provide their users with rich experiences not possible just a few years ago. For example, many mobile media playback devices now include an ability to transmit and receive wireless communications. The ability to communicate wirelessly has further increased the utility of mobile media playback devices. Wireless communications allow mobile media playback devices to access electronic networks such as the Internet. However, some wireless communication channels may offer inconsistent availability and/or may not adequately support high bandwidth communications, such as may be required for delivering media files.

U.S. Pat. No. 7,099,848 to Bratton (“the '848 patent”) discloses methods of delivering media to an electronic device, including dividing a media file into a “residual” data file (hereinafter referred to as a “RAD” file) and an “essential” data file (hereinafter referred to as an “EA” file). The RAD file has had at least one portion removed from each of a plurality of locations within the media file. The EA file includes the portions that were removed. Neither the RAD file, nor the EA file are usable as media files individually. Rather, the RAD and EA files must be recombined in order to render the original media file. The RAD file is typically much larger than the EA file and may be communicated via a first communication channel for storage on the electronic device. The EA file is typically much smaller than the RAD file and is not stored on the electronic device. Rather, when a user wishes to play the media file, the EA file is streamed to the electronic device via a second communication channel. Thus, most of the data needed to render a media file (i.e., the RAD file) may be securely stored on an electronic device, but the media file cannot be rendered without the EA file.

U.S. patent application Ser. No. 10/046,933 to Bratton, et al., is a continuation-in-part of the '848 patent and is directed to power saving methods of streaming media files to a portable computing device. A RAD file is communicated to and stored on a portable device via a high-bandwidth communication channel. When a user wishes to play the media file, the portable device needs to turn on a wireless receiver only for as long as is needed to receive the relatively small EA file. Once the EA file is received, the portable device may turn off the wireless receiver, saving power. The EA file is not stored on the portable device and must be streamed via the wireless receiver each time the user wishes to play the media file.

The above-cited applications are incorporated herein by reference in their entireties, for all purposes.

Bratton's methods of encoding and communicating a media file via RAD and EA files has been commercially adopted by the Rhapsody streaming media service, which is operated by Real Networks, Inc. of Seattle Wash. (the current assignee of the present application, as well as the above-cited applications). However, the need to communicate an EA file to a device each time a media track is played may be a disadvantage in certain contexts.

For example, many users may wish to consume media on mobile phones or other mobile media devices that may lack sufficient resources to obtain and/or process EA files in a timely manner. Using methods such as those described above, a mobile play device may not provide a satisfactory user media play experience if, for example, the device cannot establish a reliable and/or fast wireless data connection at the moment a user wishes to play a particular track. Thus, in at least some cases, methods such as those described above, unavailable, unreliable, and/or unsuitable wireless data connections may hinder a user from playing a desired media track on a mobile play device.

### BRIEF DESCRIPTION OF THE DRAWINGS

FIG. 1 is a system diagram showing a number of interconnected devices in accordance with one embodiment.

FIG. 2 is a block diagram of a media server device that provides an exemplary operating environment for various embodiments.

FIG. 3 is a block diagram of a mobile play device that provides an exemplary operating environment for various embodiments.

FIG. 4 is a diagram illustrating packaged and un-packaged media files in accordance with one embodiment.

FIG. 5 is a data-flow diagram illustrating a mobile media play device obtaining packaged media from a media server in accordance with one embodiment.

FIG. 6 is a flow diagram illustrating a routine for providing securely packaged media in accordance with one embodiment.

FIG. 7 is a flow diagram illustrating a play device license key generation subroutine in accordance with one embodiment.

FIG. 8 is a flow diagram illustrating a package media-content data block subroutine in accordance with one embodiment.

FIG. 9 is a flow diagram illustrating a play secure media routine in accordance with one embodiment.

FIG. 10 is a flow diagram illustrating an obtain packaged media files subroutine in accordance with one embodiment.

FIG. 11 is a flow diagram illustrating an unpackage media file segments subroutine in accordance with one embodiment.

FIG. 12 is a diagram illustrating an exemplary media encryption scheme in accordance with one embodiment.

### DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications, and equivalents. In alternate embodiments, additional devices, or combinations of illustrated devices, may be added to, or combined, without limiting the scope to the embodiments disclosed herein.

Some of the limitations of current implementations may be addressed by storing both RAD and EA files on a mobile media play device, thereby enabling a user to play a media track regardless of data network availability. However, storing EA files on a mobile play device opens up potential security concerns, as all of the data needed to play a particular media file would then be stored locally. (Both the RAD file and the EA file are typically encrypted, and it would be nontrivial for an attacker to recombine the two, but it would be much easier to recreate a media file if an attacker had access to both the RAD file and the EA file.)

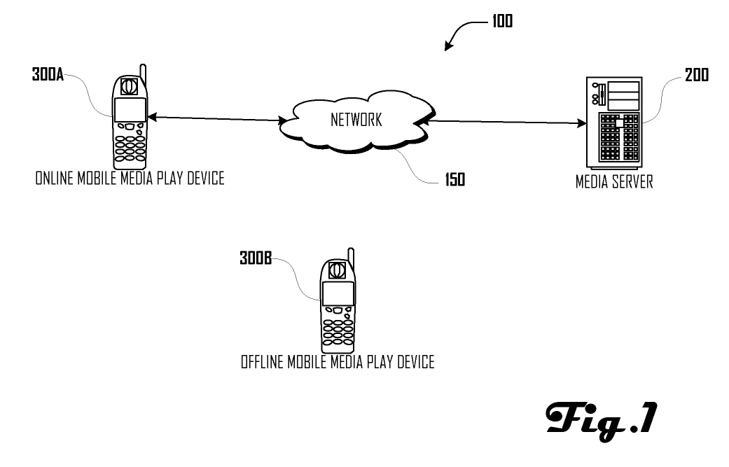

FIG. 1 illustrates a number of interconnected devices in accordance with one embodiment. Online mobile media play device 300A and media server 200 are connected to network 150. Offline media play device 300B is not connected to network 150. As used herein, the term “online” refers to a state of being connected to a network, such as network 150. Conversely, the term “offline” refers to a state of being disconnected from a network, such as network 150. In some embodiments, a mobile media play device 300 may be online or offline depending on various factors, such as wireless signal strength, the type and/or capacity of an available power source, device settings, and the like. Some mobile media play devices 300 may lack the capability to go online.

In various embodiments, network 150 may comprise communication switching, routing, and/or data storage capabilities. In various embodiments, network 150 may comprise some or all of the Internet, one or more intranets, a cellular data network, and wired and/or wireless network portions. In various embodiments, there may be additional media servers 200 and/or mobile media play devices 300A-B (not shown).

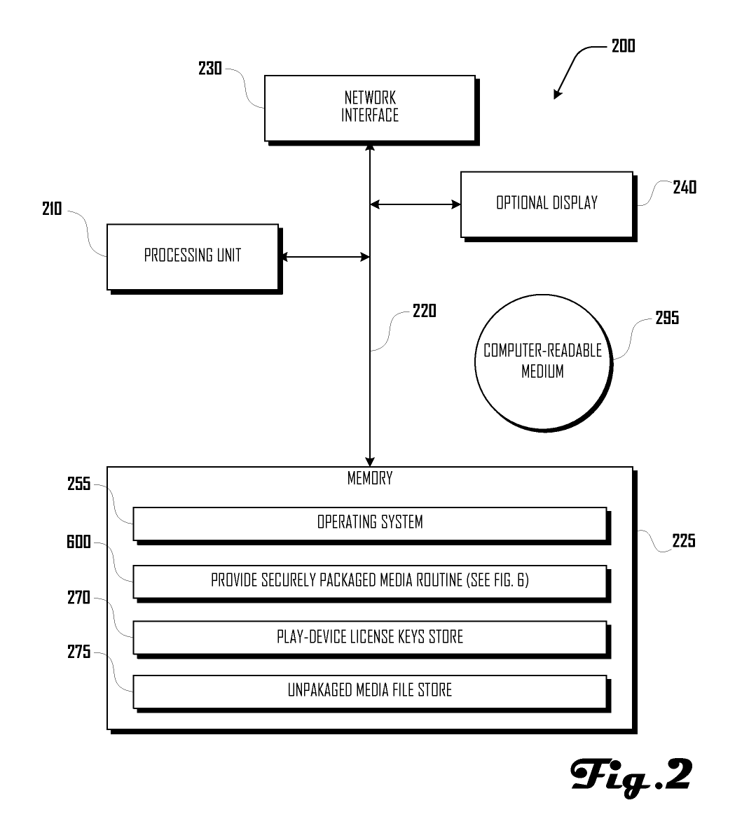

FIG. 2 illustrates several components of an exemplary media server device 200. In some embodiments, media server 200 may include many more components than those shown in FIG. 2. However, it is not necessary that all of these generally conventional components be shown in order to disclose an illustrative embodiment. As shown in FIG. 2, media server 200 includes a network interface 230 for connecting to network 150. Network interface 230 includes the necessary circuitry for such a connection and is constructed for use with an appropriate protocol.

Media server 200 also includes a processing unit 210, a memory 225, and an optional display 240, all interconnected, along with network interface 230, via bus 220. Memory 225 generally comprises a random access memory (“RAM”), a read only memory (“ROM”), and/or a permanent mass storage device, such as a disk drive. In some embodiments, memory 225 may also comprise a local and/or remote database, database server, and/or database service.

Memory 225 stores program code for some or all of a provide securely packaged media routine 600. In addition, memory 225 also stores an operating system 255, a play-device license keys store 270, and an unpackaged media file store 275. In various embodiments, play-device license keys store 270 and/or unpackaged media file store 275 may comprise a local or remote database, media, and/or file server. These and other software components may be loaded from a computer readable storage medium 295 into memory 250 of device 200 using a drive mechanism (not shown) associated with the computer readable storage medium 295, such as a floppy disc, tape, DVD/CD-ROM drive, memory card. In some embodiments, software components may also be loaded via the network interface 230 or other non-storage media.

In some embodiments, media server 200 may comprise one or more devices such as that illustrated in FIG. 2. In other embodiments, media server 200 may comprise one or more virtualized servers, web services, and/or other computing devices.

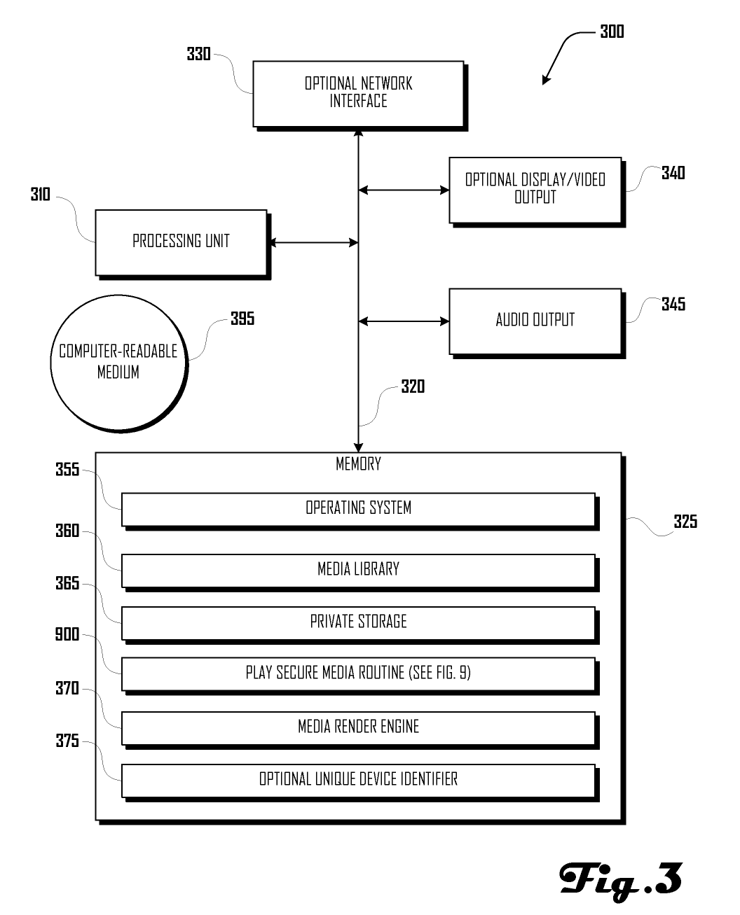

FIG. 3 illustrates several components of an exemplary mobile media play device 300. In some embodiments, device 300 may include many more components than those shown in FIG. 3. However, it is not necessary that all of these generally conventional components be shown in order to disclose an illustrative embodiment. In various embodiments, mobile media play device 300 may be one or several types of media play devices, including desktop computers; laptop computers; mobile phones, mobile media players, and other mobile devices; PDAs; set-top boxes; game devices; appliances; and the like. In an exemplary embodiment, mobile media play device 300 may be a mobile phone or other mobile play device based on Java Platform, Micro Edition (“Java ME”), Android (developed by the Open Handset Alliance), Windows Mobile (provided by Microsoft Corporation of Redmond, Wash.), or other such application platform. In one embodiment, a Java ME device may implement PDA Optional Packages for the Java ME Platform (JSR 75) and Mobile Media API (JSR 135).

As shown in FIG. 3, mobile media play device 300 includes an optional network interface 330 for connecting to network 150. If present, network interface 330 includes the necessary circuitry for such a connection and is constructed for use with an appropriate protocol.

Device 300 also includes a processing unit 310, a memory 325, an optional display or video output 340, and an audio output 345, all interconnected, along with optional network interface 330, via bus 320. Memory 325 generally comprises a random access memory (“RAM”), a read only memory (“ROM”), and/or a persistent storage device, such as a disk drive, flash storage, removable storage card, and the like. For example, a removable storage card may include Micro SD, Compact Flash, MultiMedia Card, Secure Digital card, and the like.

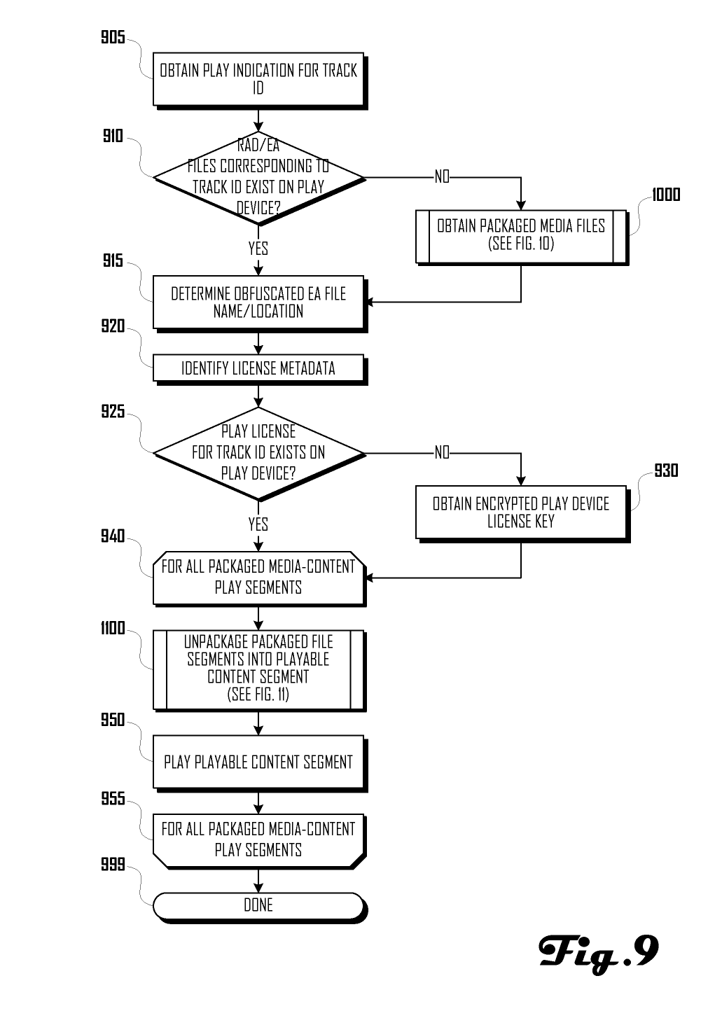

Memory 325 also stores program code for some or all of a play secure media routine 900, and a media render engine 370. In some embodiments, play secure media routine 900 (see FIG. 9, discussed below) provides media data to media render engine 370, which renders the media data to audio output 345 and optionally to display/video output 340. In addition, memory 325 also stores an operating system 355 and an optional unique device identifier, such as an International Mobile Equipment Identity (“IMEI”), a Mobile Station International Subscriber Directory Number (“MSISDN”), and/or other unique identifier. These and other software components may be loaded from a computer readable storage medium 395 into memory 325 of device 300 using a drive mechanism (not shown) associated with a computer readable storage medium 395, such as a floppy disc, tape, DVD/CD-ROM drive, memory card. In some embodiments, software components may also be loaded via the network interface 330 or other non-storage media.

Memory 325 further includes a media library 360. In some embodiments, media library 360 may comprise a folder or directory structure designated to hold media content. Media files and other content stored in media library 360 may be accessible by a user via a media play and/or management interface on mobile media play device 300. In some embodiments, media library may be stored on a removable storage card and/or internal storage drive that a user may be able to read to and/or write from via a desktop computer or other computing device. Generally speaking, a moderately sophisticated user may be able to gain at least read access to media library 360 with relative ease. Therefore, a media publisher, distributor, and/or copyright holder may wish to secure media files stored in media library 360.

Memory 325 also includes “private” storage 365. As used herein, the term “private” storage refers to a storage location that is at least somewhat harder for a user access than media library 360. The actual implementation of private storage 365 may vary considerably from one mobile media play device 300 to another, depending on the devices capabilities. Some mobile media play devices 300 may provide a relatively sophisticated security model, including strong encryption capabilities, access-control list permissions, physically separate storage devices for user-accessible and user-inaccessible files, and the like. At the other end of the spectrum, many mobile media play devices 300, including many handsets based on Java ME, may merely provide weak or no encryption capabilities, no permissions-based access control, identical storage device for user-accessible and user-inaccessible files, and the like. Thus, the distinction between media library 360 and private storage 365 necessarily varies according to the capabilities offered by various mobile media play devices 300.

For example, in various embodiments, media library 360 may reside on a storage card or internal storage drive that a user may be able to mount on a desktop computer or other computing device, where contents of the media library 360 may be susceptible to attack by a malicious user. In one embodiment, private storage 365 might reside on a separate storage device from media library. In other embodiments, private storage 365 might reside on the same storage device, but in a location that is not user-accessible when the storage device is mounted on another computing device. In further embodiments, private storage 365 might reside on the same storage device, but in an obscured and/or obfuscated location that would be difficult for a user to discover. In embodiments with less-capable mobile media play devices 300, a storage location may be treated as “private” storage 365 merely by obfuscating file names within an otherwise accessible directory.

The examples provided above illustrate a variety of options for private storage 365, ranging from more secure private storage 365 (e.g., separate, inaccessible, and/or encrypted storage device) to relatively less secure private storage 365 (e.g., obfuscated file names within an otherwise user-accessible directory). As a general rule, it may be desirable to implement a secure form of private storage 365 that the capabilities of a particular mobile media play device 300 reasonably provide. A guiding principle is hindering a user from identifying files in private storage 365 and/or from correlating files in private storage 365 to corresponding files in media library 360.

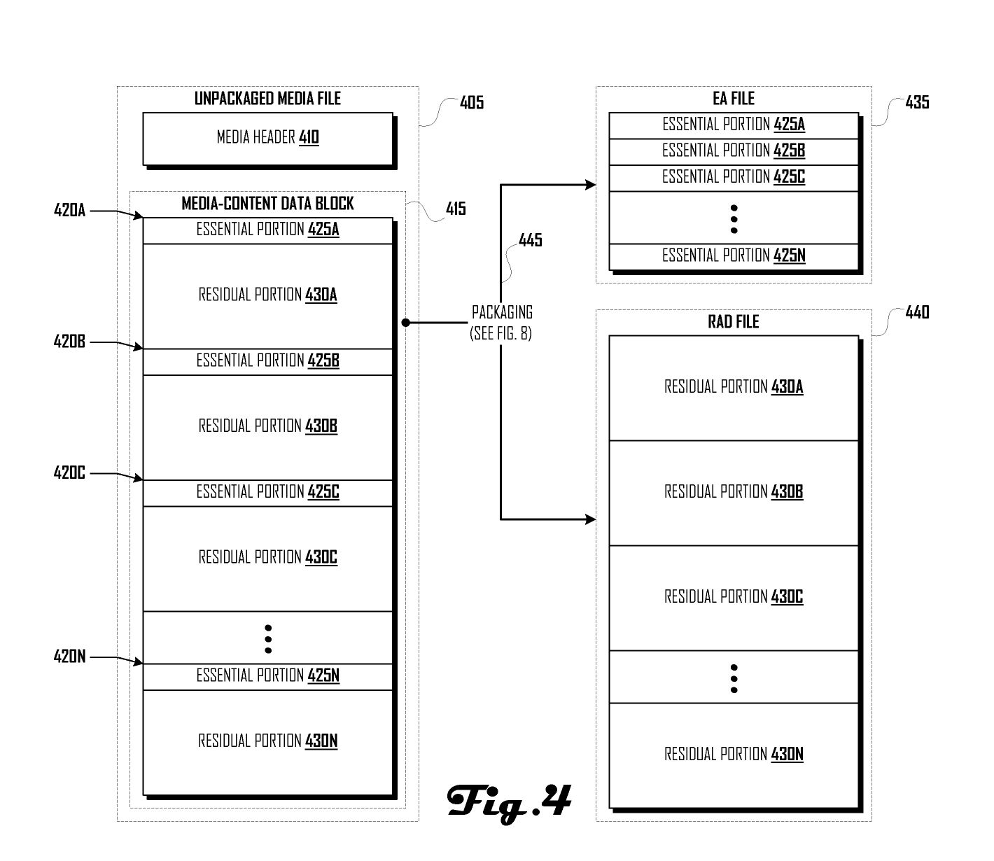

FIG. 4 illustrates the basic concepts behind packaged 435, 440 and un-packaged 405 media files in accordance with one embodiment. Unpackaged media file 405 may include data having a variety of types and formats, such as video data, audio data, animation data, and other time-based-media data. Unpackaged media file 405 typically includes one or more header blocks 410 that, among other things, describes the file's contents and organization. In one embodiment, unpackaged media file 405 may adhere to an International Organization for Standardization (“ISO”) media file format, such as MPEG-4 part 12 base media file format, or a more specific media container format, such as 3rd Generation Partnership Project file format (“3GP”).

Unpackaged media file 405 also includes a media-content data block 415. In some embodiments, media-content data block 415 may include media data that has been compressed and/or encoded according to a scheme such as MPEG-4 Part 2, H.263, H.264, Advanced Audio Coding (“AAC”), High-Efficiency Advanced Audio Coding (“HE-AAC”) version 1 or 2, and the like.

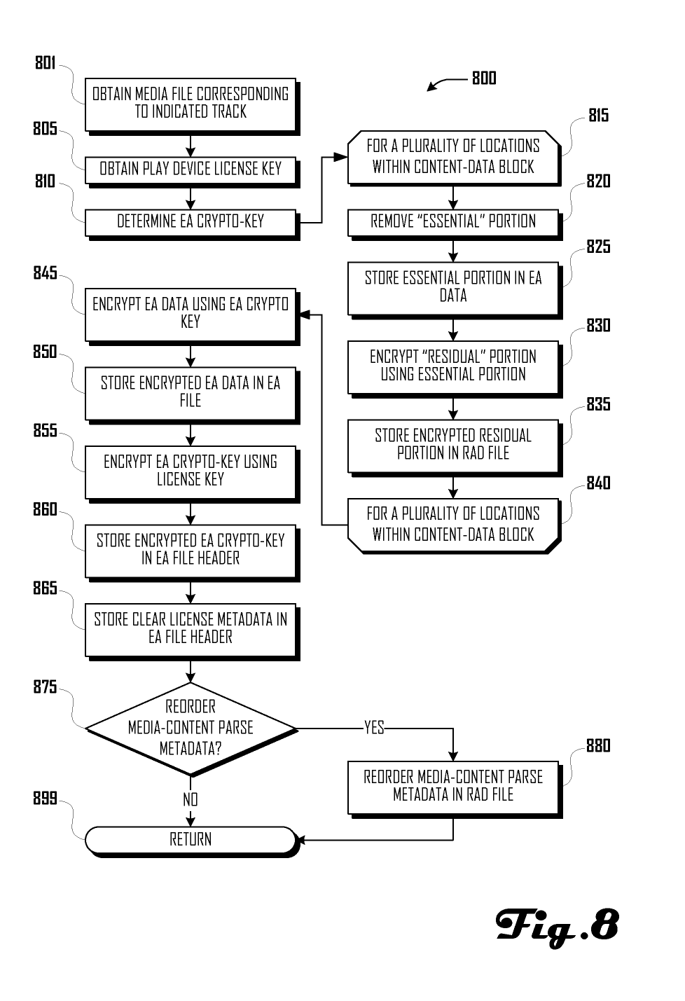

Via a packaging process 445 (see FIG. 8, discussed below), “essential” media-content data portions 425A-N are removed from a plurality of locations 420A-N from within media-content data block 415 and stored in EA file 435. The remaining or “residual” media-content data portions 430A-N of media-content data block 415 become part of RAD file 440. In one embodiment, essential portions 425A-N may comprise 16-bytes of media-content data, while residual portions 430A-N may comprise 2048 bytes of data. In some embodiments, any remaining bytes from the end of media-content data block 415 may be appended to the end of RAD file 440. In some embodiments, an essential portion, e.g. 425A, may be used to encrypt a corresponding residual portion, e.g. 430A. In some embodiments, one or both of EA file 435 and RAD file 440 may be further encrypted and/or processed. Moreover, in many embodiments, one or both of EA file 435 and RAD file 440 may further comprise one or more header blocks and/or cryptographic keys. FIG. 8, discussed below, illustrates an exemplary packaging process in greater detail.

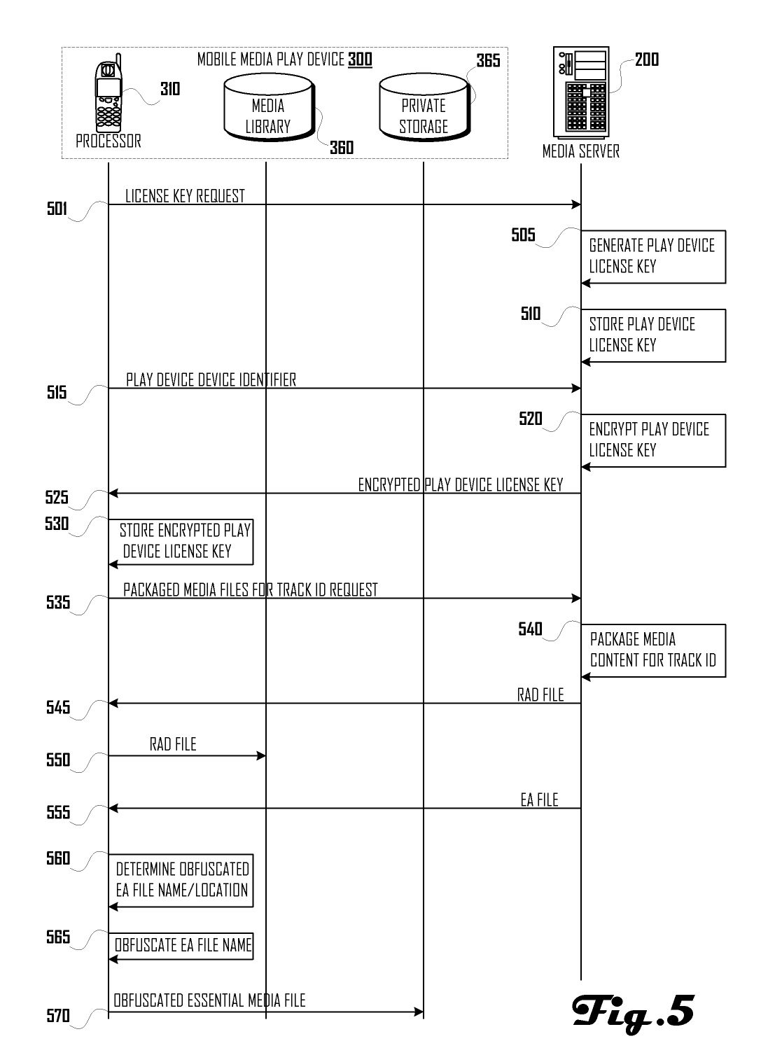

FIG. 5 is a data-flow diagram illustrating a mobile media play device obtaining packaged media from a media server in accordance with one embodiment. Mobile media play device 300 requests a license key from media server 200. For example a user of mobile media play device 300 may have expressed interest in and/or subscribed to a music service associated with media server 200. Media server 200 generates 505 a license key for mobile media play device 300 and stores a copy of the generated license key in an accessible play-device license keys store 270. In one embodiment, the generated license key is unique to the mobile media play device 300 and/or to a user account associated with the mobile media play device 300.

Media server 200 obtains 515 a device identifier from mobile media play device 300, encrypts 520 the generated license key with the device identifier, and communicates 525 the encrypted license key to mobile media play device 300. In some embodiments, the device identifier may comprise an IMEI, a MSISDN, and/or other identifier 375 unique to or associated with the mobile media play device 300. In other embodiments, the device identifier may comprise a randomly generated identifier, a timestamp, and the like.

Mobile media play device 300 stores 530 the encrypted license key. In some embodiments, the encrypted license key may be stored in a location separate from where packaged media files are stored. In one embodiment, the encrypted license key may be stored in Java Record Management System (“RMS”) persistent storage.

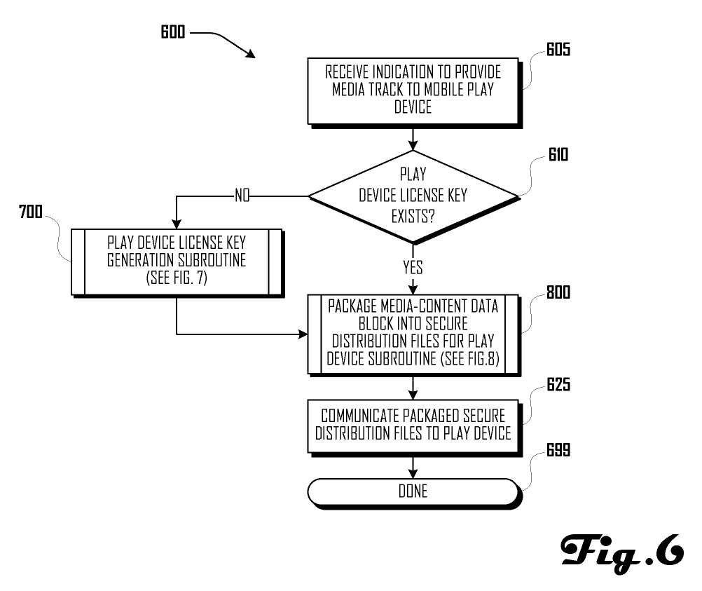

At some point after mobile media play device 300 has obtained its play device license key, as discussed immediately above, mobile media play device 300 requests 535 packaged media files for a particular media track identifier (“track ID”) from media server 200. (In some embodiments, mobile media play device 300 may obtain its license key concurrently with or subsequent to requesting packaged media files. See, e.g., FIG. 6, discussed below.) Upon receiving the request, media server 200 packages 540 a media file corresponding to the requested track ID into RAD and EA files for the requesting mobile media play device 300. (See FIG. 6, discussed below.) Media server 200 communicates 545 the packaged RAD file to mobile media play device 300, which stores the RAD file in mobile media play device's media library 360.

Media server 200 communicates 545 the packaged EA file to mobile media play device 300 which determines 560 an obfuscated name and optional obfuscated location for the EA file (see also FIG. 9, discussed below). Mobile media play device 300 renames the EA file with the obfuscated name and stores 570 the EA file in the determined obfuscated location or other location in mobile media play device's private storage 365.

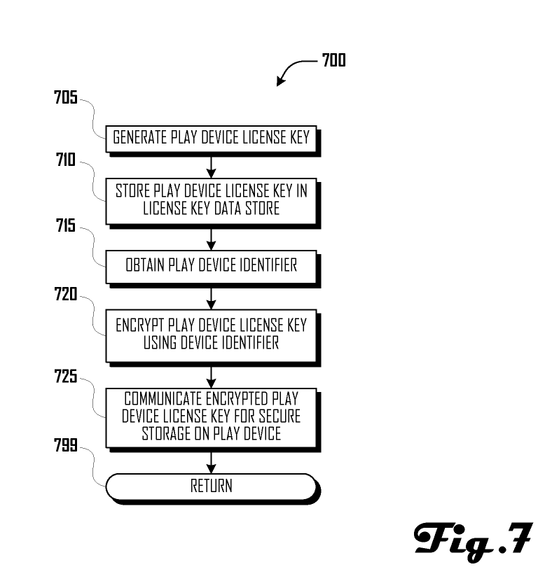

FIG. 6 illustrates a secure packaged media routine 600 for providing securely packaged media, such as might be performed by a media server 200 in accordance with one embodiment. In block 605, routine 600 receives an indication to provide a media track (identified by a track ID) to the mobile media play device 300 that sent the indication. In decision block 610, routine 600 consults play-device license keys store 270 to determine whether the mobile media play device 300 already has a device license key. If the mobile media play device 300 does not have a license key, routine 600 performs play device license key generation subroutine 700, as illustrated in FIG. 7 and discussed below.

In subroutine block 800, routine 600 packages media-content data corresponding to the track ID into secure distribution files (i.e., RAD and EA files) for the mobile media play device 300. Packaging subroutine 800 is illustrated in FIG. 8 and discussed below.

In block 625, routine 600 communicates the packaged RAD and EA files to mobile media play device 300, and routine 600 ends at block 699. In some embodiments, communicating the packaged secure distribution files may comprise streaming one or both of the packaged RAD and EA files to mobile media play device 300 via network 150 when playback is requested. In one embodiment, a packaged RAD file may be requested and delivered via a standard Hypertext Transfer Protocol (“HTTP”) connection, while a packaged EA file may be requested and delivered via a Hypertext Transfer Protocol Secure (“HTTPS”) connection. In other embodiments, communicating the packaged secure distribution files may comprise side-loading one or both of the packaged RAD and EA files to mobile media play device 300 prior to a playback request. For example, one or both of the packaged RAD and EA files may be transferred to mobile media play device 300 via a serial connection, e.g. Universal Serial Bus (“USB”); wireless protocol, e.g. Bluetooth; and/or by writing to a removable storage card for insertion into mobile media play device 300. In still other embodiments, a mobile media play device 300 may be delivered to a user with one or more packaged RAD and EA files pre-loaded into memory 325. These and similar embodiments may enable offline media play.

FIG. 7 illustrates a play device license key generation subroutine 700 in accordance with one embodiment. In block 705, subroutine 700 generates a license key for a particular mobile media play device 300 and/or for a particular user account associated with the same. In various embodiments, a license key may comprise encrypted and/or clear information that subroutine 700 can use to determine whether mobile media play device 300 is licensed to play the media track corresponding to the requested track ID. In some embodiments, a license key may license mobile media play device 300 to play media files corresponding to one or more track IDs, genres, artists, and the like. In other embodiments, a license key may license mobile media play device 300 to play all available content from media server 200. A license key may be generated and/or processed according to any suitable method.

In block 710, subroutine 700 stores the generated license key in play-device license keys store 270. In block 715, subroutine 700 obtains a device identifier from mobile media play device 300. As discussed above, the device identifier may comprise an IMEI, MSISDN, and/or other identifier unique to or associated with the mobile media play device 300. In some embodiments, subroutine 700 may further generate and/or obtain additional keys associated with mobile media play device 300 and/or a user associated with the same.

In block 720, subroutine 700 encrypts the generated license key using the device identifier, and in block 725, subroutine 700 communicates the encrypted license key for secure storage in mobile media play device 300. As discussed above, in some embodiments, the encrypted license key may be stored on mobile media play device 300 in Java Record Management System (“RMS”) persistent storage. Subroutine 700 returns in block 799.

FIG. 8 illustrates a package media-content data block subroutine 800 in accordance with one embodiment. In block 801, subroutine 800 obtains an unpackaged media file 405 corresponding to the indicated track ID from unpackaged media file store 275. In block 805, subroutine 800 obtains a license key for the media play device (see FIG. 7, discussed above). In block 810, subroutine 800 determines a crypto-key for encrypting the EA file that will be packaged (“EA crypto-key”). In one embodiment, the EA crypto-key may comprise a randomly generated key of the same size as an essential media-content data portion 425A-N (e.g. 16-bytes). In other embodiments, the EA crypto-key may comprise a time-stamp or other deterministic value. In some embodiments, the EA crypto-key may comprise an identifier associated with the mobile media play device 300 and/or a user account.

In beginning loop block 815, subroutine 800 iterates over a plurality of locations 420A-N within the media-content data block 415 of the unpackaged media file 405 corresponding to the indicated track ID. In one embodiment, the number of locations may be pre-determined (e.g., there may be 128 locations). In other embodiments, the number of locations may be determined based on the size of media-content data block (e.g., there may be a location every 1040, 2064, or N bytes).

In block 820, subroutine 800 removes a number of bytes at the current location, e.g. 420A, to form an “essential” media-content data portion, e.g. 425A. The remaining bytes up to the next location, e.g. 420B, form a “residual” media-content data portion, e.g. 430A. In block 825, subroutine 800 stores the current essential media-content data portion, e.g. 425A, in an EA data buffer or interim file.

In block 830, subroutine 800 encrypts the current residual media-content data portion, e.g. 430A, using the current essential media-content data portion, e.g. 425A. In various embodiments, encrypting the current residual portion may be accomplished in a variety of ways. For example, in one embodiment, the current essential portion may be used as a crypto-key to encrypt the current residual portion using a symmetric-key cryptographic algorithm.

In other embodiments, counter-mode encryption may be utilized to protect the current residual media-content data portion. For example, the current essential media-content data portion (having a length of N bytes) may be encrypted with the EA crypto-key, and the resulting encrypted essential media-content data portion may be logically exclusively disjoined (i.e. “XOR'd”) with the first N bytes of the current residual media-content data portion. The encrypted essential media-content data portion may then be incremented and encrypted again with the EA cypto-key. This result is XOR'd with the next N bytes of the current residual media-content data portion. This process is repeated until the entire residual media-content data portion has been protected.

In block 835, subroutine 800 stores the encrypted current residual media-content data portion, e.g. 430A, in the RAD file 440 corresponding to the track ID. From ending loop block 840, subroutine 800 iterates back to loop block 815 until all locations within media-content data block 415 have been processed. In one embodiment, if there is any data remaining within media-content data block 415, the remaining data may be appended to the RAD file 440.

In block 845, subroutine 845 encrypts the EA data buffer or interim file. As discussed above, the EA data buffer or interim file includes the unencrypted essential media-content data portion 425A-N that were removed in iterations of block 820. In block 850, subroutine 800 stores the encrypted EA data buffer or interim file to a data portion of EA file 435.

In block 855, subroutine 800 encrypts the EA crypto-key with the license key, and in block 860, subroutine 800 stores the encrypted EA crypto-key in a header portion of EA file 435. In block 865, subroutine 800 stores clear metadata associated with the license key in a header portion of EA file 435. For example, in one embodiment, subroutine 800 may store information that would facilitate a media play device to locate the play device's copy of the license in the play device's private storage. In most embodiments, a copy of the license itself is not stored in EA file 435.

In decision block 875, subroutine 800 determines whether to reorder media-content parse metadata in RAD file 440. Referring briefly to FIG. 4, unpackaged media files 405 often contain several blocks including media-content data block 415 and one or more non-media-content or header data blocks 410. For example, an ISO-formatted unpackaged media file 405 may include media-content data block 415 (e.g. “mdat” block), as well as non-media-content data 410 such as a file type header (e.g. “ftyp” block) and metadata useful for parsing the mdat block (e.g. “moov” block). Various media file format specifications may allow these and other data blocks to occur in different orders within a media file. For example, some 3GP files may have the mdat (media-content) block before the moov (media parse metadata) block. As the moov block is useful for parsing the mdat block in 3GP files, this ordering may not be desirable in some circumstances. For example, when the moov block is located after the mdat block, then the entire media file must often be downloaded before any part of it can be played back. In some embodiments, it may be desirable to reorder such blocks during packaging so that playback of a media file may commence before all of its media-content data has been obtained.

Referring again to FIG. 8, in decision block 875, subroutine 800 determines whether to reorder media-content parse metadata (e.g., a moov block) to occur before media-content data (e.g., a mdat block) in the packaged RAD file. If the unpackaged media file already has media-content parse metadata occurring before media-content data, then reordering may not be necessary, and the media-content parse metadata may be left in place in the RAD file. However, if the unpackaged media file has media-content parse metadata occurring after media-content data, then routine 800 branches to block 880, in which blocks within the RAD file are re-ordered such that media-content parse metadata occurs before media-content data. Subroutine 800 returns at block 899.

Pseudo-code for an exemplary embodiment of encrypting the current residual media-content data segment, such as is illustrated in FIG. 8, is as follows:

int segmentIndex = 0;
int blockIndex;
foreach location within media-content data block {

{ create essentialPortion, residualPortion from input }
{ write essentialPortion to eaData }
for (i = 0; i < residualPortionLength; i+= keyLength) {

encrypt(essentialPortion, eaCryptoKey);
encrypt(residualPortion + i, essentialPortion);

}
{ write residualPortion to RAD file }

}
encrypt(eaData, eaCryptoKey);
{ write eaData to EA file }
encrypt(eaCryptoKey, deviceLicenseKey);
{ write eaCryptoKey to EA file header }

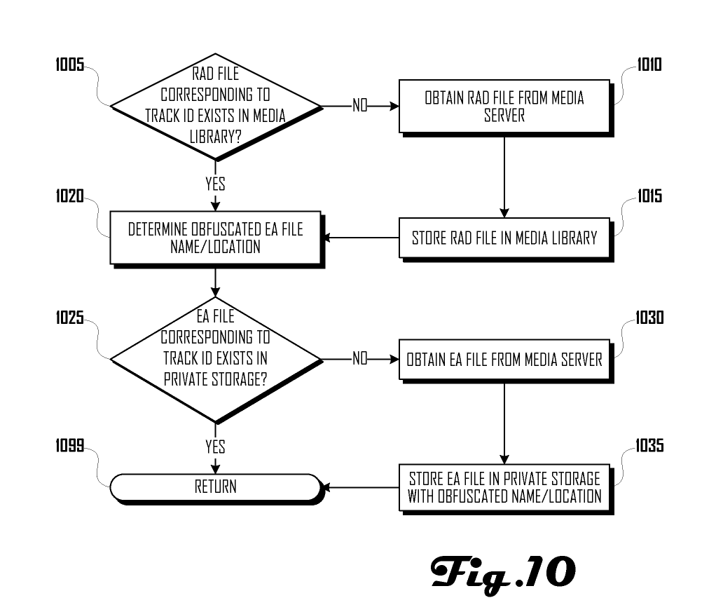

FIG. 9 illustrates a play secure media routine 900, such as may be performed by mobile media play device 300, in accordance with one embodiment. In block 905, routine 900 obtains a play indication for a track ID. For example, a user may select a media track and issue a “play” command. In decision block 910, routine 900 determines whether packaged media files corresponding to the indicated track ID exist on the play device. If not, routine 900 performs obtain packaged media files subroutine 1000. (See FIG. 10, discussed below.)

When packaged media files corresponding to the indicated track ID exist on the play device, in block 915, routine 900 determines an obfuscated file name and/or location for a packaged EA file corresponding to the indicated track ID. In some embodiments, routine 900 may determine such a file name and/or location via a one-way algorithm (i.e., an algorithm that is “easy” to compute for a given input, but “hard” to invert, in terms of computational complexity). For example, in one embodiment, routine 900 may provide track-identifying information (e.g., a track ID and a genre ID or other identifier) to a cryptographic hash function, which outputs a unique identifier used to name the EA file.

Using the determined obfuscated EA file name and/or location, routine 900 reads header information from the EA file and in block 920, identifies metadata for a license key associated with the track ID. (Cf. block 865 in FIG. 8.) For example, in one embodiment, the packaged EA file header may include clear-text metadata indicating the name and/or location of an associated license key stored in private storage 365.

In decision block 925, routine 900 determines whether the indicated license key exists in private storage 365. If not, in some embodiments, routine 900 obtains an encrypted play device license key in block 930. For example, in one embodiment, routine 900 may obtain a license key after the mobile play device's user registers with media server 200 and/or purchases a license from media server 200. In some embodiments, if routine 900 cannot obtain a license key, an error message may be presented, and routine 900 may end without playing the indicated track ID.

Once routine 900 has determined that a play license key for the indicated track ID exists on mobile play device 200, routine 900 enters a play loop, beginning in block 940, in which one or more packaged media-content play segments are unpackaged and played. In various embodiments, the number of media-content play segments may depend on one or more capabilities of the mobile play device 300 and/or media render engine 370.

For example, in one embodiment, media render engine 370 may support a streaming playback method, in which routine 900 acts as a data source supplying media data on request to media render engine 370. In such an embodiment, routine 900 may process the requested media track in many relatively small segments. For example, media render engine 370 may request media data from routine 900 in, e.g., 1000 byte segments, assembling the stream of segments into a continuous stream of rendered media.

In other embodiments, media render engine 370 may not support a streaming playback method. Rather, media render engine 370 may be able to render only discrete, non-continuous segments of media data. (I.e., in some embodiments, media render engine 370 may be configured to process only complete, playable media files.) In such embodiments, routine 900 may preferably process the requested media track as a single play segment.

However, in some embodiments, mobile play device 300 may lack sufficient resources (e.g., processing capability, network bandwidth, and/or memory) to un-package the entire indicated media track in a timely manner. For example, in one embodiment, the indicated media track may comprise a three-minute song, and mobile play device's processing unit 310 may require 45 seconds to process the entire media track. Thus, if routine 900 processed the media track as a single segment, the user would have to wait 45 seconds before he or she could begin to listen to the song, a delay that may present an unacceptable user media play experience. To mitigate the delay, routine 900 may, in one embodiment, process the media track as a first 40-second segment and a second 140-second segment. Thus, the user would have to wait only approximately ten seconds before the first segment began to play. While the first segment is playing, routine 900 may have time to process the second segment, such that the second segment is ready to play as soon as the first segment ends. In some embodiments, this method of non-continuous segment playback may result in a gap, click, or other audible/visible artifact when media render engine 370 switches from rendering the first segment to the second segment. However, in some cases, this artifact may be preferable to making the user wait for the entire track to be processed before playback can begin.

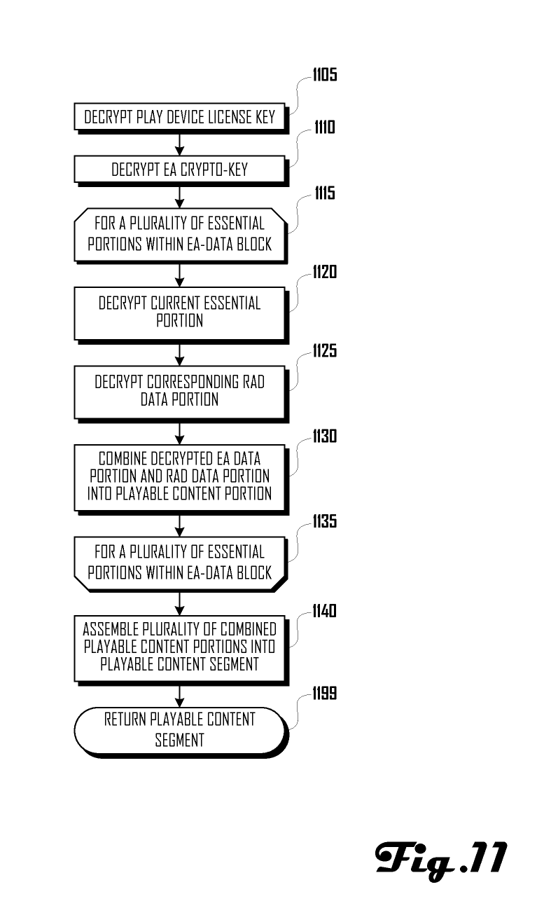

Thus, in various embodiments, as described above, routine 900 may process a packaged media file as a stream of continuous play segments, as a single discrete play segment, or as two or more discrete play segments. Beginning in loop block 940, routine 900 iterates over each play segment. In subroutine 1100, segments of the packaged RAD 440 and EA 435 files are unpackaged into a playable media-content segment. (See FIG. 11, discussed below.) In block 950, routine 900 provides the playable media-content segment to media render engine 370, which renders the segment to audio output 345 and optionally to display/video output 340. In ending loop block 955, routine 900 iterates back to block 940 to process the next media-content play segment, until all play segments for the media track have been played. Routine 900 ends at block 999.

FIG. 10 illustrates an obtain packaged media files subroutine 1000 in accordance with one embodiment. In decision block 1005, subroutine 1000 determines whether a RAD file 440 corresponding to the indicated track ID exists in media library 360. If not, in block 1010, subroutine 1000 obtains the RAD file 440 from media server 200. In one embodiment, the RAD file 440 may be requested and obtained via a standard HTTP connection. (Cf. block 625 in FIG. 6.) In block 1015, subroutine 1000 stores the RAD file in media library 360.

When the RAD file 440 corresponding to the indicated track ID exists in media library 360, subroutine 1000 in block 1020 determines an obfuscated file name and/or location in private storage 365 for the EA file 435 corresponding to the indicated track ID. (See FIG. 9 block 915, discussed above.) In decision block 1025, subroutine 1000 determines whether the EA file 435 exists at the determined obfuscated name and/or location. If the EA file 435 corresponding to the indicated track ID does not exist in private storage 365, subroutine 1000 obtains the EA file 435 from media server 200. In one embodiment, the EA file 435 may be requested and obtained via a secure HTTPS connection. (Cf. block 625 in FIG. 6.) In block 1035, subroutine 1000 stores the EA file in private storage 365 using the determined obfuscated name and/or location. When the EA file 435 corresponding to the indicated track ID exists in private storage 365, subroutine 1000 returns at block 1099.

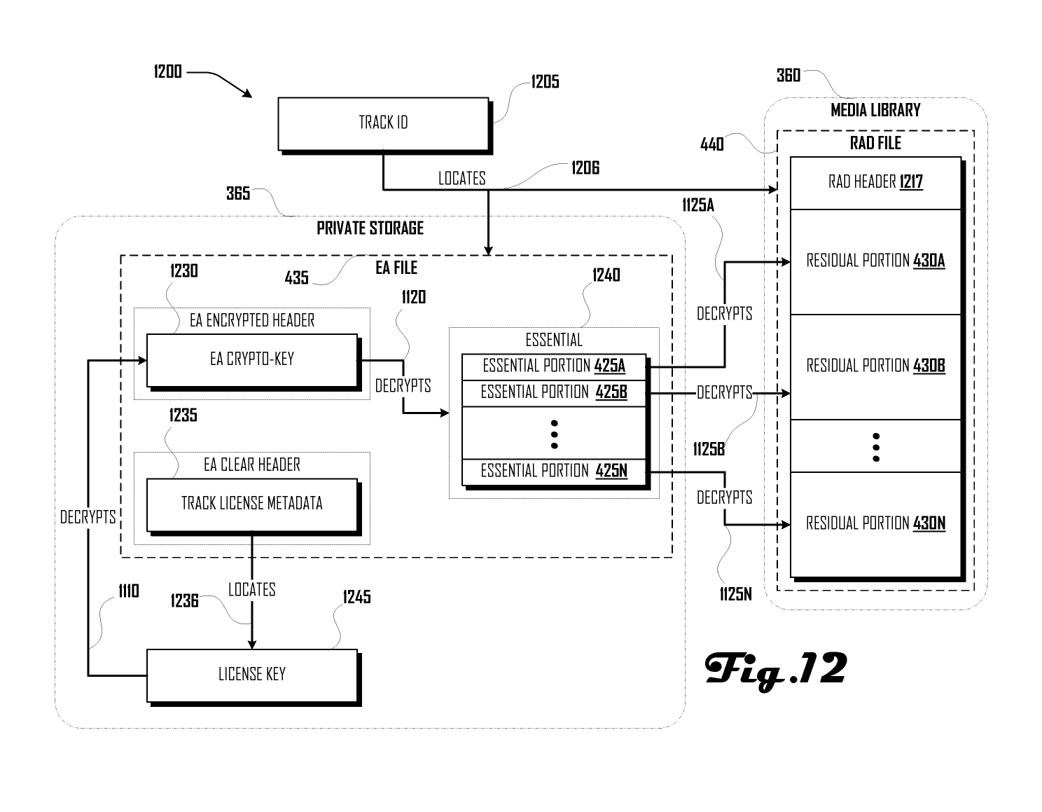

FIG. 11 illustrates an un-package media file segments subroutine 1100 in accordance with one embodiment. (See also FIG. 12, discussed below.) In block 1105, subroutine 1100 decrypts a license key 1245 for mobile media play device 300 from private storage 365. In one embodiment, license key 1245 is decrypted via a secret algorithm known to mobile play device 300 and media server 200. (Cf. FIG. 5 block 505, discussed above.) Using the decrypted license key in block 1110, subroutine 1100 decrypts an EA crypto-key 1230 from an encrypted header portion of EA file 435.

Beginning in loop block 1115, subroutine 1100 iterates over a plurality of essential portions within EA data bock 1240 of EA file 435. (Cf. FIG. 8 blocks 820 and 825, discussed above.) Using the decrypted EA crypto-key 1230 in block 1120, subroutine 1100 decrypts the current essential portion. In one embodiment, subroutine uses an iterative counter-mode or other cryptographic process complementary to that used to encrypt the current essential portion. See FIG. 8 block 830, discussed above.

Using the decrypted current essential portion in block 1125, subroutine 1100 decrypts a corresponding residual portion from the RAD file 440 corresponding to the indicated track ID. In block 1130, subroutine 1100 combines the decrypted current essential portion with the decrypted corresponding residual portion to form a playable media-content portion. In ending loop block 1135, subroutine 1100 iterates back to loop block 1115 until all of the plurality of essential portions have been processed.

Once all of the plurality of essential portions have been processed, in block 1140, subroutine 1100 assembles the plurality of combined playable content portions (collected during loop iterations from blocks 1115-35) into a playable media-content segment, and subroutine 1100 ends at block 1199.

FIG. 12 graphically depicts cryptographic relationships between keys and data in an exemplary media encryption scheme in accordance with one embodiment. More specifically, FIG. 12 illustrates graphical relationships between keys and data used by various embodiments of the routines illustrated in FIGS. 9-11, discussed above.

Track ID 1205 includes information that may be used to locate 1206 a corresponding EA file 435 (in private storage 365) and RAD file 440 (in media library 360). (Cf. FIG. 9 block 910.) Within EA file 435, a clear-text header block includes track license metadata 1235 (cf. FIG. 8 block 865) that may be used to locate 1236 license key 1245, also in private storage 365 (cf. FIG. 9 blocks 920, 925).

License key 1245 may be used to decrypt 1110 EA crypto-key 1230 from an encrypted header block in EA file 435. EA crypto-key 1230 may be used to iteratively decrypt 1120 essential portions 425A-N from EA data block 1240. Decrypted essential portions 425A-N may be used in turn to decrypt 1125A-N corresponding residual portions 430A-N from RAD file 440.

Although specific embodiments have been illustrated and described herein, a whole variety of alternate and/or equivalent implementations may be substituted for the specific embodiments shown and described without departing from the scope of the present disclosure. This application is intended to cover any adaptations or variations of the embodiments discussed herein.

We claim:

1. A method for providing a rights-managed media track to a mobile media playback device via a media server, the method comprising:
receiving, at the media server, an indication to provide the media track to the mobile playback device;
in response to receiving said indication, obtaining, from an electronic data store, an unprotected media file corresponding to the media track, said unprotected media file comprising a header block and a media-content data block;
packaging said media-content data block into first and second data files by the media server, said first data file comprising said media-content data block having at least one content-data portion removed from each of a plurality of locations within said media-content data block, and said second data file comprising at least one content-data portion removed from each of said plurality of locations within said media-content data block;
encrypting at least a portion of said first data file using a first cryptographic key;
encrypting at least a portion of said second data file using a second cryptographic key;
communicating said first encrypted data file to the media playback client for non-obfuscated, persistent storage; and
communicating said second encrypted data file to the media playback client for obfuscated, persistent storage.

2. The method of claim 1, further comprising:
generating a client license associated with the mobile media playback device;
communicating said client license for storage on the mobile media playback device.

3. The method of claim 2, further comprising encrypting said client license prior to communicating said client license for storage on the mobile media playback device.

4. The method of claim 2, wherein said second cryptographic key comprises at least part of said client license.

5. The method of claim 1, wherein said first cryptographic key comprises at least part of said second data file.

6. The method of claim 1, further comprising packaging said header block into a non-encrypted portion of said first data file.

7. The method of claim 6, wherein said header block comprises metadata for parsing said media-content data block, and wherein packaging said header block into a non-encrypted portion of said first data file comprises placing said non-encrypted portion ahead of said encrypted portion within said first data file.

8. A computer-readable storage medium having stored thereon instructions that, when executed by a processor, perform the method of claim 1.

9. A computing apparatus comprising a processor and memory storing instructions that, when executed by the processor, perform the method of claim 1.

10. A method for processing a media track on a mobile media playback device, the method comprising:
obtaining an indication to play a selected media track, said indication comprising a track identifier, said selected media track corresponding to a media-content data block;
identifying, in accordance with said track identifier, an encrypted first data file corresponding to said track identifier, wherein said first data file comprises said media-content data block having at least one content-data portion removed from each of a plurality of locations within said media-content data block;
identifying, in accordance with at least one of said track identifier and said encrypted first data file, an encrypted second data file corresponding to said track identifier, wherein said encrypted second data file comprises the content-data portions removed from each of said plurality of locations within said media-content data block;
verifying that a license associated with the mobile media playback device permits playing the selected media track;
decrypting at least a first portion of said encrypted first data file and at least a second portion of said encrypted second data file, wherein the decrypted first and second portions are not individually playable as media content;
combining the decrypted first and second portions into a first playable portion of said media-content data block; and
playing said first playable portion of said media-content block.

11. The method of claim 10, wherein said encrypted first data file is stored in a non-obfuscated manner on the mobile media playback device, and wherein said encrypted second data file is stored in an obfuscated manner on the mobile media playback device.

12. The method of claim 11, wherein identifying said encrypted second data file comprises determining an encrypted-second-data-file identifier via a one-way algorithm in accordance with at least a portion of said track identifier.

13. The method of claim 10, further comprising:
obtaining said encrypted first data file and said encrypted second data file from a media server via a communication channel.

14. The method of claim 13, wherein obtaining said encrypted second data file comprises transmitting a request via said communication channel using a cryptographic protocol.

15. The method of claim 10, further comprising determining that the mobile media playback device cannot, within a determined amount of time, generate a playable portion comprising all of said media-content data block, and wherein said first playable portion of said media-content data block includes less than all of said media-content data block.

16. The method of claim 10, further comprising:
while playing said first playable portion of said media-content block:
decrypting a third portion of said encrypted first data file and a fourth portion of said encrypted second data file, wherein the decrypted third and fourth portions are not individually playable as media content;
combining the decrypted third and fourth portions into a second playable portion of said media-content data block; and
upon completion of said playing said first playable portion of said media-content block:
playing said second playable portion of said media-content block.

17. The method of claim 10, wherein receiving said indication to play a selected media track comprises receiving, from a media player routine, an indication to provide a first streaming buffer of playable media data from said media-content block.

18. The method of claim 17, further comprising:
obtaining, from said media player routine, a plurality of subsequent indications to provide a plurality of subsequent streaming buffers of playable media data from said media-content block; and
for each of said plurality of subsequent indications:
decrypting a first subsequent portion of said encrypted first data file and a second subsequent portion of said encrypted second data file, wherein the decrypted first and second subsequent portions are not individually playable as media content;
combining the decrypted first and second subsequent portions into a subsequent playable portion of said media-content data block; and
providing said subsequent playable portion to said media player routine.

19. A computer-readable storage medium having stored thereon instructions that, when executed by a processor, perform the method of claim 10.

20. A computing apparatus comprising a processor and a memory storing instructions that, when executed by the processor, perform the method of claim 10.
